(19) United States
(12) Patent Application Publication
(10) Pub. No.: US 2009/0255134 A1
(43) Pub. Date: Oct. 15, 2009

(54) Cutting blade holder

(75) Inventor: Kris R. Boutin, Mont Vernon, NH (US)

Correspondence Address: Harrington & Smith PC, 4 Research Drive, Suite 202, Shelton, CT, 06484, US

(73) Assignee: FCI Americas Technology, Inc.

(21) Appl. No.: 12/082,580

(22) Filed: Apr. 11, 2008

(51) Int. Cl. B26B 29/00

(52) U.S. Cl. 30/329

(57) ABSTRACT

A holder including a main section; a plurality of pockets on a first side of the main section, wherein each pocket is sized and shaped to receive at least a portion of a tool cutting blade therein; and mounting pins on the main section at respective entries into each of the pockets. Each of the mounting pins are sized and shaped to be inserted into a mounting hole of the cutting blade when the cutting blade is inserted into the respective pocket. Each pair of the pockets and mounting pins are adapted to cooperate to hold the respective cutting blades on the holder until the blades are removed by a user.

### BACKGROUND OF THE INVENTION

1. Field of the Invention

The invention relates to a holder and, more particularly, to a holder for holding cutting blades.

2. Brief Description of Prior Developments

Some types of cutting tools have cutting blades which can be removed from the tool. One type of cutting tool is a hydraulically actuated tool. The cutting blade has a rear end with a mounting hole. The cutting tool has a movable pin which is inserted into the mounting hole to removably mount the cutting blade to the tool. One example of a hydraulic tool having removable cutting dies is described in U.S. Pat. No. 6,792,789 which is hereby incorporated by reference in its entirety. It is customary for a user to have multiple cutting blades in the event one of the blades becomes damaged or dull because of numerous use.

Crimping dies used with hydraulically actuated tool are customarily stored in a canvas bag or loosely in bins of a metal carry case. Cutting blades cannot be carried in a canvas bag because the bag would be cut by the blades. Cutting blades stored loosely in bins of a metal carry case can be damaged by chipping or breaking when not in use during transport.

There is a desire to provide a holder for a cutting blade which can prevent the blade from chipping or being damaged when not in use.

### SUMMARY OF THE INVENTION

In accordance with one aspect of the invention, a holder is provided including a main section; a plurality of pockets on a first side of the main section, wherein each pocket is sized and shaped to receive at least a portion of a tool cutting blade therein; and mounting pins on the main section at respective entries into each of the pockets. Each of the mounting pins are sized and shaped to be inserted into a mounting hole of the cutting blade when the cutting blade is inserted into the respective pocket. Each pair of the pockets and mounting pins are adapted to cooperate to hold the respective cutting blades on the holder until the blades are removed by a user.

In accordance with another aspect of the invention, a holder is provided comprising a main section; a plurality of pockets on a first side of the main section, wherein each pocket is sized and shaped to receive a front end of a tool cutting blade therein, wherein the pockets comprise at least one column of the pockets aligned with entries into the pockets all facing generally a same direction towards an end of the main section; and supplemental cutting blade retainment systems on the main section at entries into each of the pockets. Each supplemental cutting blade retainment system is sized and shaped to attach to a rear end of one of the cutting blades when the front end of the cutting blade is inserted into the respective pocket. The pockets and respective supplemental cutting blade retainment systems are adapted to cooperate with each other to hold the cutting blades on the holder until the blades are removed by a user.

In accordance with another aspect of the invention, a holder is provided comprising a flexible main section; a plurality of pockets on a first side of the main section, wherein each pocket has a partially flexible roof section, wherein each pocket is sized and shaped to receive a front end of a tool cutting blade therein, wherein the pockets comprise at least one column of the pockets aligned with entries into the pockets all facing generally a same direction towards an end of the main section; and mounting pins on the main section at respective entries into each of the pockets. Each of the mounting pins are sized and shaped to be inserted into a mounting hole of the cutting blade when the cutting blade is inserted into the respective pocket. Each pair of the pockets and mounting pins are adapted to cooperate to hold the respective cutting blades on the holder until the blades are removed by a user.

### BRIEF DESCRIPTION OF THE DRAWINGS

The foregoing aspects and other features of the invention are explained in the following description, taken in connection with the accompanying drawings, wherein:

FIG. 1 is a front plan view of a holder comprising features of the invention with cutting blades mounted in the pockets of the holder;

FIG. 2 is a cross sectional view of the holder and blades shown in FIG. 1;

FIG. 3 is an enlarged view of one of the pockets shown in FIG. 2;

FIG. 4 is a partial front plan view of an alternate embodiment of the invention;

FIG. 5 is a cross sectional view of another alternate embodiment of the invention;

FIG. 6 is a front plan view of another alternate embodiment of the invention; and

FIG. 7 is a top plan view of a tool casing or carry case having a tool therein and the holder of FIG. 6 mounted into the casing.

### DETAILED DESCRIPTION OF THE PREFERRED EMBODIMENTS

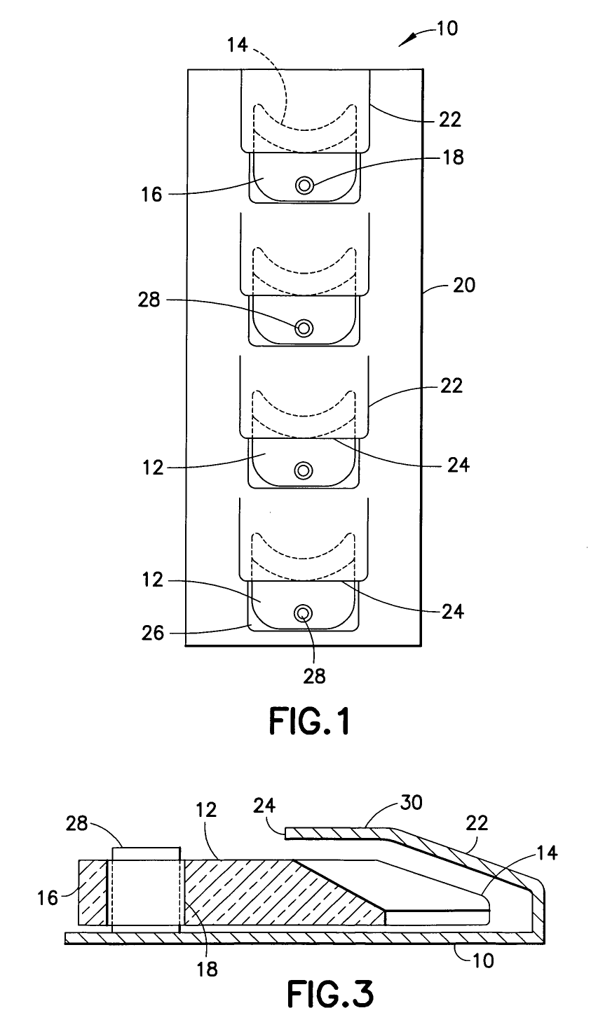

Referring to FIG. 1, there is shown a front view of a holder 10 incorporating features of the invention. Although the invention will be described with reference to the exemplary embodiments shown in the drawings, it should be understood that the invention can be embodied in many alternate forms of embodiments. In addition, any suitable size, shape or type of elements or materials could be used.

The holder 10 is adapted to hold or store members 12. In this embodiment the members 12 comprise cutting blades. The cutting blades 12 are adapted to be removably mounted to a working head of a hydraulically operated cutting tool. One type of industrial application uses the tool to cut metal electrical conductors for example. In the embodiment shown, the holder is adapted to individually store four of the cutting blades 12. However, in alternate embodiments the holder could be adapted to store more or less than four blades.

The blades 12 each comprise a front end 14 having a relatively sharp cutting edge, and a rear end 16 adapted to removably mount the blade to the tool. The rear ends of the blades 12 each comprise a mounting hole 18. The mounting hole 18 is sized and shaped to receive a pin of the tool in order to removably mount the blade with the tool.

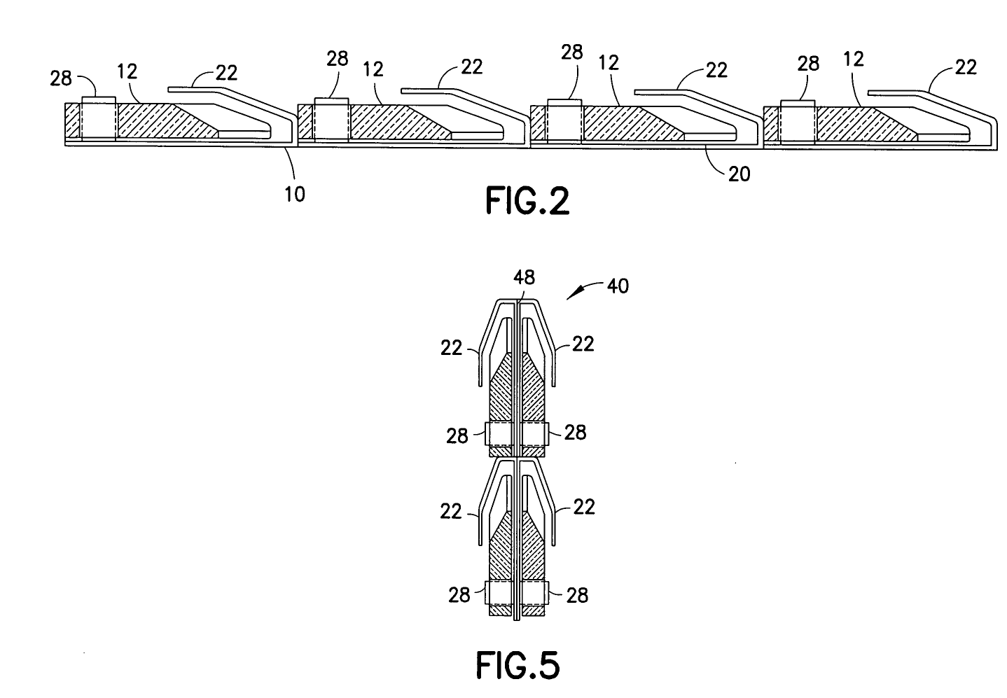

The holder 10 generally comprises a main section 20 and a plurality of pockets 22. In a preferred embodiment the main section 20 and the pockets 22 are comprised of a single molded plastic or polymer member. However, in alternate embodiments multiple members and/or different materials could be used to form the main section and the pockets. In the embodiment shown, the holder 10 has four pockets 22. However, in alternate embodiments more or less than four pockets could be provided. Referring also to FIGS. 2-3, each pocket 22 is sized and shaped to receive at least the front end 14 of one of the blades 12. In this embodiment the entries 24 into the pockets 22 all face a same direction; towards an end of the main section 22. However, in alternate embodiments the entries 24 could face more than one direction. Also in this embodiment the pockets 22 are aligned in a single column along the longitudinal length of the main section. However, in an alternate embodiment the pockets could be arranged in any suitable orientation or pattern relative to each other including multiple columns and/or rows.

In this embodiment the main section 20 has a generally flat sheet shape. However, in alternate embodiments a shape other than a flat sheet shape could be provided. In a preferred embodiment the main section 20 is at least partially flexible. However, in alternate embodiments the main section might not be flexible. The main section 20 could also have a slight recess 26 in front of the entry 24 to each pocket and perhaps forming a portion of the pocket. However, the recess 26 need not be provided.

Each pocket 22 is sized and shaped to receive a front end of one of the cutting blades 12. The pockets 22 are designed to protect the front ends of the cutting blades from being chipped or broken during storage. In a preferred embodiment the roof 30 of each pocket is slightly resiliently flexible. However, in alternate embodiments the roof 30 might not be flexible. In a preferred embodiment the shape of the roof 30 closely resembles the shape of the front end of the cutting blade; at least as illustrated by the cross sectional view shown in FIG. 3.

In this embodiment the holder 10 also comprises a mounting pin or resting pin 28 associated with each pocket 22. Each pin 28 is sized and shaped to be received in one of the mounting holes 18 of a blade 12 when the blade 12 is inserted into the respective associated pocket 22. The pins 28 could be integrally formed with the main section 20 when the main section is formed, such as from molded plastic for example. Alternately, the pins 28 could be subsequently attached to the main section 20.

As shown in the figures, each pin 28 is located in front of the entry 24 of one of the pockets 22. When a blade 22 is inserted into the pocket 22, the main section 20 and/or the roof 30 of the pocket can flex to accommodate clearance of the blade over the pin 28 until the hole 18 and the pin 28 align with each other. Then, the blade 12 can seat as shown in the figures with the pin 28 acting as a supplemental retainment system to keep the blade 12 in the pocket 22 until the blade is intentionally removed by a user. In order to remove the blade from the holder, the user can pull on the rear end 16 of the blade to disengage the hole 18 from the pin 28 and slide the blade out of the pocket 22. In a preferred embodiment the pocket 22 and/or the main section 20 flex in order to accomplish disengagement of the hole 18 from the pin 28. However, in alternate embodiments other types of supplemental retainment system(s) could be provided at each pocket.

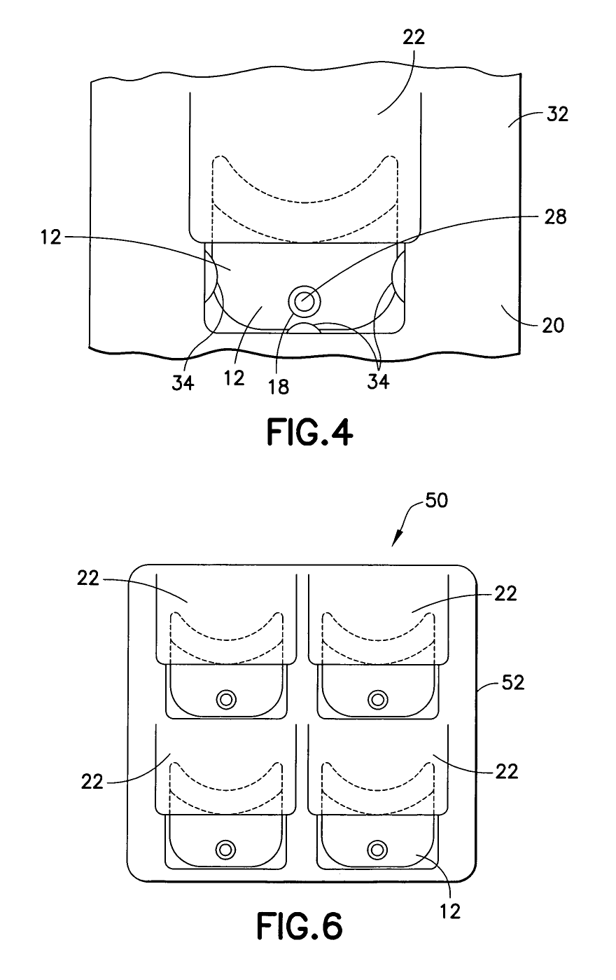

Referring now also to FIG. 4, an alternate embodiment of the invention is shown. In this embodiment the holder 32 is identical to the holder 10 except that the supplemental retainment system at the pocket 22 includes press fit portions 34 on the main section 20 which are sized and shaped to engage lateral sides and end side of the cutting blade 12. Thus, the press fit portions 34 are sized and shaped to attach to a rear end of one of the cutting blades when a front end of the cutting blade is inserted into the respective pocket.

Referring now also to FIG. 5, an alternate embodiment of the invention is shown. In this embodiment the holder 40 comprises a main section 42, pockets 22, and mounting pins 28. However, the pockets 22 and pins 28 are located on opposite main sides of the main section 42 as shown. This illustrates that, rather than merely one column of pockets, the pockets can be arranged in multiple columns and/or on multiple sides of a holder.

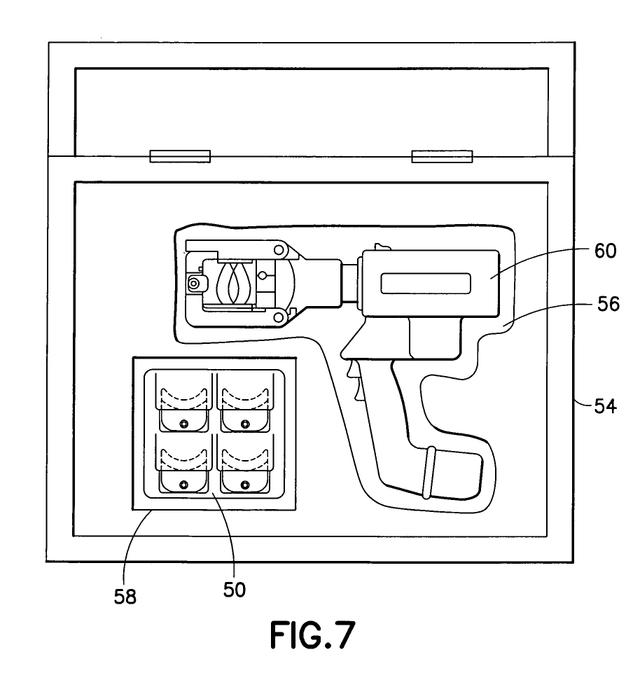

Referring also to FIG. 6, another alternate embodiment of the invention is shown. In this embodiment the holder 50 comprises a main section 52, pockets 22, and mounting pins 28. The pockets 22 are arranged in multiple columns and rows. The pockets 22 could be located on one or more sides of the main section 52. The holder 50 could be adapted to be mounted into a tool casing as shown in FIG. 7. In FIG. 7, the casing 54 can be made of plastic or metal and comprises recesses 56, 58 for the hydraulically operated cutting tool 60 and the holder 50. However, in alternate embodiments, any suitable connection of the holder 50 to a tool casing could be provided.

It should be understood that the foregoing description is only illustrative of the invention. Various alternatives and modifications can be devised by those skilled in the art without departing from the invention. For example, features recited in the various dependent claims could be combined with each other in any suitable combination(s). Accordingly, the invention is intended to embrace all such alternatives, modifications and variances which fall within the scope of the appended claims.

What is claimed is:

1. A holder comprising:
a main section;
a plurality of pockets on a first side of the main section, wherein each pocket is sized and shaped to receive at least a portion of a tool cutting blade therein; and
mounting pins on the main section at respective entries into each of the pockets, wherein each of the mounting pins are sized and shaped to be inserted into a mounting hole of the cutting blade when the cutting blade is inserted into the respective pocket, and wherein each pair of the pockets and mounting pins are adapted to cooperate to hold the respective cutting blades on the holder until the blades are removed by a user.

2. A holder as in claim 1 wherein the main section is comprised of a plastic or polymer material.

3. A holder as in claim 1 wherein the main section is at least partially resiliently flexible.

4. A holder as in claim 1 wherein the main section and the pockets are comprised of a one piece molded plastic or polymer member.

5. A holder as in claim 1 wherein the pockets are also located on a second opposite side of the main section.

6. A holder as in claim 1 wherein the holder is part of a tool case adapted to hold a hydraulic cutting tool.

7. A holder as in claim 1 wherein the main section is a substantially flat sheet member.

8. A holder as in claim 1 further comprising detent holding members at the entries to the pockets, wherein the detent holding members are adapted to make a detent holding engagement with a side of one the cutting blades at each pocket entry.

9. A holder as in claim 1 further comprising supplemental cutting blade retainment systems on the main section at the entries into each of the pockets, wherein each supplemental cutting blade retainment system is sized and shaped to attach to a rear end of one of the cutting blades when a front end of the cutting blade is inserted into the respective pocket, wherein the supplemental cutting blade retainment systems each comprise one of the mounting pins and at least one other feature on the main section which engages the rear end of the cutting blade.

10. A holder as in claim 9 wherein the at least one other feature comprises press fit portions on the main section which are sized and shaped to engage a lateral side and/or end side of the cutting blade.

11. A holder as in claim 1 wherein the pockets comprise at least one column of the pockets aligned with each other with the entries into the pockets all facing generally a same direction towards an end of the main section.

12. A holder as in claim 11 wherein the pockets comprise at least two columns of the pockets with the entries into the pockets all facing a generally same direction towards an end of the main section.

13. A holder comprising:
a main section;
a plurality of pockets on a first side of the main section, wherein each pocket is sized and shaped to receive a front end of a tool cutting blade therein, wherein the pockets comprise at least one column of the pockets aligned with entries into the pockets all facing generally a same direction towards an end of the main section; and
supplemental cutting blade retainment systems on the main section at entries into each of the pockets, wherein each supplemental cutting blade retainment system is sized and shaped to attach to a rear end of one of the cutting blades when the front end of the cutting blade is inserted into the respective pocket, and wherein the pockets and respective supplemental cutting blade retainment systems are adapted to cooperate with each other to hold the cutting blades on the holder until the blades are removed by a user.

14. A holder as in claim 13 wherein the supplemental cutting blade retainment systems each comprise a mounting pin on the main section at respective entries into each of the pockets, wherein each of the mounting pins are sized and shaped to be inserted into a mounting hole of the cutting blade when the cutting blade is inserted into the respective pocket.

15. A holder as in claim 14 wherein the supplemental cutting blade retainment systems each comprise press fit portions on the main section which are sized and shaped to engage a lateral side and/or end side of the cutting blade.

16. A holder as in claim 13 wherein the supplemental cutting blade retainment systems each comprise press fit portions on the main section which are sized and shaped to engage a lateral side and/or end side of the cutting blade.

17. A holder as in claim 13 wherein the main section is at least partially resiliently flexible.

18. A holder as in claim 13 wherein the main section and the pockets are comprised of a one piece molded plastic or polymer member.

19. A holder as in claim 13 wherein the pockets are also located on a second opposite side of the main section.

20. A holder as in claim 13 wherein the main section is a substantially flat sheet member.

21. A holder as in claim 13 wherein the pockets comprise at least two columns of the pockets with the entries into the pockets all facing the generally same direction towards the end of the main section.

22. A holder comprising:
a flexible main section;
a plurality of pockets on a first side of the main section, wherein each pocket has a partially flexible roof section, wherein each pocket is sized and shaped to receive a front end of a tool cutting blade therein, wherein the pockets comprise at least one column of the pockets aligned with entries into the pockets all facing generally a same direction towards an end of the main section; and
mounting pins on the main section at respective entries into each of the pockets, wherein each of the mounting pins are sized and shaped to be inserted into a mounting hole of the cutting blade when the cutting blade is inserted into the respective pocket, and wherein each pair of the pockets and mounting pins are adapted to cooperate to hold the respective cutting blades on the holder until the blades are removed by a user.
